(19) United States
(12) Patent Application Publication
(10) Pub. No.: US 2010/0199919 A1
(43) Pub. Date: Aug. 12, 2010

(54) No-Mess Pet Cafe

(76) Inventor: Peter Mariner, Superior, CO (US)

Correspondence Address: MEGAN LYMAN, 1816 SILVER MIST CT., RALEIGH, NC, 27613, US

(21) Appl. No.: 12/370,564

(22) Filed: Feb. 12, 2009

(51) Int. Cl. A01K 1/10; A01K 15/04; A01K 1/035

(52) U.S. Cl. 119/416; 119/52.4; 119/61.5

(57) ABSTRACT

The present invention is an animal feeder that allows for continued feeding, over a multitude of days if desired, of a smaller animal and has the ability to exclude other larger animals from its interior. The animal feeder may be constructed from three separate parts and excludes other animals by way of a size-exclusionary opening.

### BACKGROUND

1. Field of Invention

This invention relates to animal feeders, particularly to a device and system for a feeding system that is accessible to one smaller animal, but is exclusionary to another larger animal. In addition, the present invention may be composed of three main interlocking elements; one being a food container that allows a caregiver to place enough food to feed the smaller animal for multiple days, thereby easing the amount of effort needed to feed the smaller animal, another being a housing chamber that is equipped with a size-exclusionary opening, and the third component being a base unit that can receive the feeding container and housing chamber, if desired.

2. Brief Description of the Prior Art

Many animal feeders have attempted to address a multitude of issues that may arise. For instance, multiple patents have been issued for devices that alleviate the caregiver's need to fill a container with food for the animal on a daily basis (See U.S. Pat. Nos. 6,401,657, 4,248,175, and 3,763,826). Other prior art recites devices that preclude other animals from entering the eating domain of one animal (See U.S. Pat. Nos. 7,458,336 and 4,793,290 and U.S. Patent Application No. 2006/0272584). The advent of small devices powered by radio frequencies to gain entry into a space, as described in U.S. Pat. No. 7,458,336, allows caregivers a high-tech and high-expense option when trying to separate different types of animals during the feeding process.

Presently, no animal feeder exists that is self-sustaining, portable, size-exclusionary and inexpensive. There is a need for animal feeders that are cost-effective, easy to use, and allow caregivers to feed one animal in a secluded environment. The present invention addresses these needs. As will be seen from the subsequent description, the preferred embodiment of the present invention overcomes these and other shortcomings of the prior art.

### SUMMARY OF THE INVENTION

Homes with multiple pets often have difficulty controlling feeding behavior of the individual pets. This is especially apparent where different animals have various dietary needs and/or preferences for their eating environment. For example, in homes where both cats and dogs reside, dogs are notorious for interfering with the cat's food and feeding environment. Meanwhile, it is not common for a cat to interfere with a dog's food. Many caregivers with both dogs and cats resort to feeding the animals in separate physical locations (rooms, counters, etc,) and at separate times, at much effort to the caregiver. A device that restricts access of larger animals to a smaller animal's food, and allows the caregiver to put enough food in the feeding system to supply the smaller animal with food, for a multitude of days if desired, would be advantageous. Such a device is not currently available.

The present invention is an animal feeder that allows for continued feeding, over a multitude of days if desired, of a smaller animal and has the ability to exclude other larger animals from its interior. The animal feeder may be constructed from three separate parts and excludes other animals by way of a size-exclusionary opening. Alternatively, the feeder may be made as one contiguous piece. The feeder may be constructed of plastics, polymers, fiberglass, epoxies, resins, polycarbonates, molding compounds, glues, woods, metals and the like.

Consequently, the animal feeder may be made up of three main interlocking parts. The first is at least one base member that sits on a floor or surface and receives the food container and may receive the housing chamber, if desired. Latches may be used to secure the base to the other main parts of the present invention. The second is a container that is adaptable for holding food, and may hold enough food to feed the smaller animal for many days. The container has at least one opening to release food to the animal and may have an upper door used to deposit the food therein. The food-loading door may be coupled to a spring or locking mechanism to prevent animal entry into the container. The feeding chamber may allow the animal access to food through gravity flow, which may be effectuated by a slope in the bottom portion of the food container, or alternatively, integrated into the base as an upper surface. Egress of food may be slowed by the presence of a flap in the opening that releases food to the animal. The third part is a housing chamber that connects to the base, forming an enclosure in which the animal is able to reside while feeding. This housing chamber contains an opening that allows the smaller animal entry to its food and prevents a larger animal from entering. An entry door that is large enough for the smaller animal to gain access to its food, but is too small to permit the entry of another larger animal, can cover the opening in the housing chamber. For example, the housing allows the entry of a house cat, but not a medium-sized domestic dog (i.e., Labrador retriever, German Shepard, Collie, etc.). The feeding container and housing chamber are adaptable to be received by the base member (or base members) to form one unit. Alternatively, the housing chamber will function adequately with no base member, while the food container does have a base member. Additionally, a food-retaining bowl may be added to the base, so that as the food flows out of the food container it fills the bowl, and prevents food from spilling into the remaining interior of the housing chamber. Still other modifications and positions of these elements may be implemented, as will be apparent to one skilled in the art.

The present invention is very affordable and easy to use in comparison with newer exclusionary feeding systems that require special collars for the animal and the door to operate and reserves enough food to feed the animal for many days. The animal feeder of the present invention may be made of inexpensive, durable, and easy to maintain materials. The animal feeder may be fabricated in a variety of sizes and shapes to accommodate caregivers with different types of animals of different sizes. Additionally, the present invention provides a simple device that works without the use of mechanical or electrical parts, which are susceptible to breakage and expense. Moreover, the fabrication of the present invention is such that the feeder is portable and may easily be transported within the home, or to other areas where the animals may be.

Positioning of the three main elements of the animal feeder of the present invention may be altered for customized use. For example, as stated above, the animal feeder functions properly with no base underneath the housing chamber. Furthermore, additional elements may be added. For example, a cover may be fabricated and placed over the housing chamber to reduce light in the housing chamber as is preferred by some animals. Such a cover also assists in creating a secluded environment that may be perceived as safer and comfortable for the feeding animal. Such a cover will also prevent larger animals from observing the feeding chamber and reduce the likelihood that they will disturb the feeding animal. Additionally, an extra chamber may be attached to the housing chamber so that an excluded animal is less likely to disturb the interior of the housing chamber, thus providing additional security and privacy to the feeding animal.

One object of the present invention is to provide a cost effective, portable, and non-technical means for a caregiver with multiple animals to provide a smaller animal an area to feed without interference from a larger animal, for a multitude of days if desired.

It is a further object of the present invention to provide an inviting area for a smaller animal to enter and eat without interference from a larger animal.

It is a further object of the present invention to provide an animal feeder that allows a caregiver to deposit food that will feed the smaller animal for a multitude of days without need to replenish the food supply by the caregiver.

It is a further objective of the present invention to provide an animal feeder that will contain food spills created by the animal, preventing such spills from spreading into the household.

It is a further objective of the present invention to provide an animal feeder that can be easily cleaned by the caregiver.

It is a further objective of the present invention to provide an animal feeder that may be used within a home and be able to be transported with ease.

Still other aspects of the present invention will become apparent to those skilled in the art from the following description of a preferred embodiment, which is by way of illustration, one of the best modes contemplated for carrying out the invention. As will be realized, the invention is capable of other different and obvious aspects, all without departing from the invention. Accordingly, the drawings and descriptions are illustrative in nature and not restrictive.

### DESCRIPTION OF THE DRAWINGS

The foregoing aspects and many of the accompanying advantages of this invention will become more readily appreciated as the same becomes understood by reference to the following detailed description, when taken in conjunction with the accompanying drawings, wherein:

FIG. 1 is a three-dimensional rendering of the animal feeder with the food container holding food from a side view, according to one preferred embodiment of the present invention.

FIG. 2 is a three-dimensional rendering of the animal feeder showing separation between the food container, housing chamber, and base unit according to one embodiment of the present invention.

FIG. 3 is a rendering of the animal feeder not filled with food and illustrating the relationship between the base, food container and housing chamber, according to one embodiment of the present invention.

FIGS. 4a, 4b, and 4c are renderings of a base, food container and housing chamber, as seen from side (FIG. 4a), front (FIG. 4b), and top views (FIG. 4c), according to one embodiment of the present invention.

FIGS. 5a and 5b are renderings of a base, food container and housing chamber, illustrating potential strategies for assembling the basic components of the invention, according to one embodiment of the present invention.

FIG. 6 is an illustration of a front cross-sectional view of the animal feeder, according to one embodiment of the present invention.

FIG. 7 illustrates the addition of an opaque cover that fits over the housing chamber to allow privacy to the feeding animal, according to one embodiment of the present invention.

FIG. 8 is a rendering of an additional chamber that may be fitted to the housing chamber to prevent a larger animal from accessing the food-retaining bowl, according to one embodiment of the present invention.

### DETAILED DESCRIPTION

The detailed explanation of the present invention is described below. The described preferred embodiments are presented for the purpose of illustration and description; they are not intended to limit the scope of the present invention. As will be apparent to one skilled in the art, modifications to described elements below may be made without deviating from the scope of the present invention.

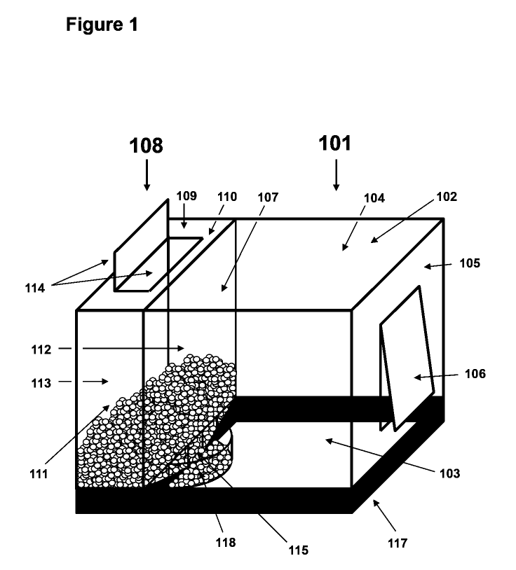

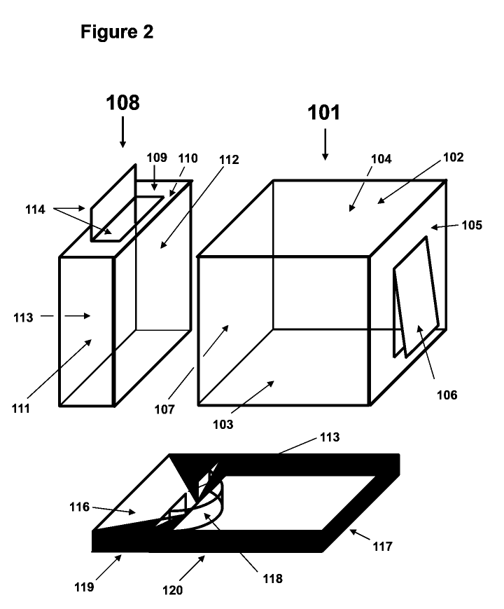

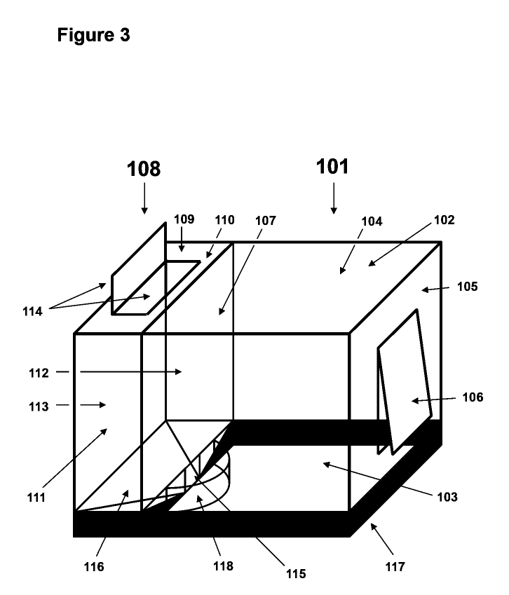

FIG. 1 shows a three-dimensional side view of the animal feeder showing the food container with food, according to one embodiment of the invention. Similarly, FIG. 3 shows the same view of the animal feeder, but without food to show the base element of the feeder. The animal feeder can be made of a variety of translucent or opaque materials including, but not limited to, plastics, polymers, fiberglass, epoxies, resins, polycarbonates, molding compounds, glues, woods, and metals. In one preferred embodiment, the animal feeder is made from plastic made by IRIS, USA. The basic elements of the animal feeder are indicated in FIG. 2. The housing chamber 101 consists of a top wall 102, left side wall 103, right side wall 104, front wall 105, and a size-excluding opening 106, shown with an optional door, as is present in one preferred embodiment of the present invention. A fourth back wall 107, may be present as in one embodiment of the invention. Alternatively, in another embodiment of the invention, no back wall 107 of the housing chamber 101 is present. The top wall 102 may be affixed to the side walls 103, 104, 105, and 107 (when present) by a variety of permanent means that are well known in the art. Alternatively, the top wall 102 and the side walls 103, 104, 105, and 107 (when present) may be made as one piece, as in the preferred embodiment.

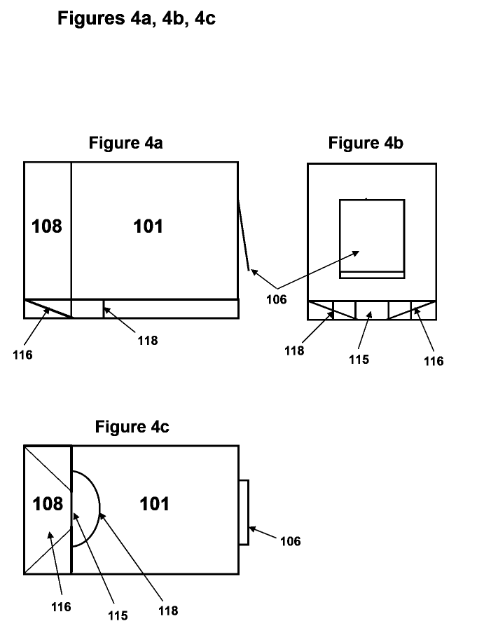

FIGS. 4a, 4b, and 4c show different views of the animal feeder. FIG. 4a illustrates a side cross-section view of the feeder, while FIG. 4b depicts a front view of the feeder. FIG. 4c shows a top view of the animal feeder. Each view corresponds with the other Figures, and the numbering of elements is identical.

The size-excluding opening 106 may be of various sizes appropriate to exclude the unwanted animal, but allow entry by the animal that is to eat the food therein. For example, in one preferred embodiment of the invention the opening is equipped with a size-excluding door 106 that is approximately 7 inches in height, and 6 inches in length. But, the invention can function properly, as is apparent to one skilled in the art, with no door, and only a size-excluding opening. A size-excluding door 106 may cover the opening, as in one embodiment of the invention, and may be affixed to the housing chamber 101 in a variety of ways, as will be apparent to one skilled in the art. In one preferred embodiment, the size-excluding door 106, is affixed to the feeding chamber 101 at the topmost section in a manner that allows the door 106 to move freely into the housing chamber 101 when pressed by the animal, and out of the feeding chamber 101 as the animal exits the feeding chamber. Moreover, while FIGS. 1-4 shows a size-excluding door 106, affixed to the front wall 105, as in the preferred embodiment, it is contemplated that the door, or a plurality of doors, may be affixed to any side wall of the feeding chamber 101.

The housing chamber 101 is shown in rectangular shape in FIGS. 1-7 as in one preferred embodiment. As would be apparent to one skilled in the art, other shapes may be implemented and have the same effect. As in the preferred embodiment, the feeding chamber 101 is approximately 13 inches in height, 16 inches in length, and 14 in width. As stated above, the feeding chamber 101 may be fabricated with a variety of materials. In one preferred embodiment, the feeding chamber 101 is made of IRIS, USA plastic because it is easy to care for, durable, and lightweight in nature.

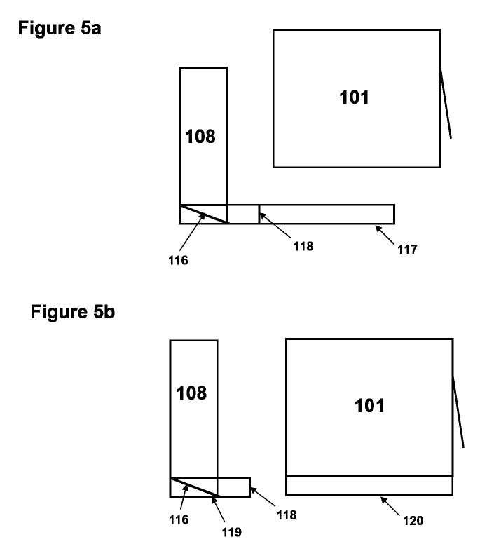

As shown in FIG. 2, the food container 108 can be a separate element that connects to the housing chamber 101 and base 117. The food container 108 has a top wall 109, right side wall 110, left side wall 111, front wall 112, and back wall 113. The top wall 109 may be affixed to the side walls 110, 111, 112, and 113 by a variety of permanent means that are well known in the art. Alternatively, the top wall 109 and the side walls 110, 111, 112, and 113 may be made as one piece, as in the preferred embodiment of the present invention. Alternatively, as shown in FIGS. 5a and b, and described further below, the food container 108, housing chamber 101, and base member 117, may interlock with one another in various ways.

The food container 108 has an opening in the top wall 109 equipped with a food-loading door 114, for the caregiver to deposit food therein. The food-loading door 114 may be spring loaded or include a securing latch to keep the door 114 in the closed position, so as to further prevent tampering with the food contained therein by animals, as in one preferred embodiment of the present invention. The food container 108 will also contain an opening 115 at the bottom to allow for the food in the food container 108 to flow into the food-retaining bowl 118. The food-retaining bowl 118 may be attached to the front wall 112 of the food container 108, or be affixed to the base member 117 as in the preferred embodiment of the present invention.

Additionally, the bottom of the food container 108 may be slanted 116 to provide a gravity-flow mechanism for the food to flow out of the opening 115 and into the food-retaining bowl 118. Alternatively, the slanted floor 116 may be part of the base member 117, as in the preferred embodiment of the present invention. As in the preferred embodiment, the food container 108 is approximately 12 inches in height, 13 inches in length, and 6 inches in width. The food-loading door 114 is approximately 10 inches in length, and 4 inches in width. In this embodiment, the food container 108 is able to hold approximately 20 pounds of domestic cat food.

Other dimensions and shapes for the food container 108 are contemplated, and do not depart from the scope of the present invention. As stated above, the food container 108 may be constructed from a variety of materials. In one preferred embodiment, the food container 108 is made of IRIS, USA plastic because it is easy to clean, translucent for monitoring food quantities, durable, and lightweight.

As is apparent to one skilled in the art, the food-loading door 114 may be affixed to the food container 108 by a variety of means, including a hinged or flap mechanism that may be coupled with a latch to prevent entry by other animals. Additionally, a simple tongue-and-groove mechanism between the top wall 109 of the food container and the food-loading door 114 will accomplish the same goal (i.e. providing means for the caregiver to load the food container 108 with food and seal the food container to prevent entry by an animal). As is apparent to one skilled in the art other shapes and sizes for the food-loading door 114 may be implemented without departing from the scope of the invention. As in the preferred embodiment, the food-loading door 114 is approximately 10 inches in length, and 4 inches in width.

As in the preferred embodiment, the slanted floor 116 is angled at about 30 degrees, and the opening 115 to the food-retaining bowl 118 is approximately 3 inches in height, and 6 inches in length. As is apparent to one skilled in the art, any fabrication that moves food down into the food-retaining bowl 118 through the opening 115 by gravity may be contemplated without departing from the scope of the present invention. The slanted floor 116 may be affixed to the side walls 110, 111, 112, and 113 of the food container 108 by a variety of means that are well known in the art. As in the preferred embodiment of the present invention, the slanted floor 116 is generally constructed of the same material as the food container 108 or base 117, IRIS, USA plastic.

As illustrated in FIGS. 1-7, a base member 117 provides a bottom surface to the animal feeder. The base member 117, as in one preferred embodiment, may be one continuous piece, with four raised edges that are adjacent to the walls 103, 104, 105, and 107 (where present, as in one embodiment) of the housing chamber 101, and the walls 110, 111, 112, and 113 of the food container 108 (FIG. 2). The base member 117 may be made of one piece or may be made by sealing a bottom portion to the four raised edges. Such construction is well known in the art. In the embodiment where the base 117 is one continuous piece, the dimensions may be approximately 25 inches in length, 17 inches in width, and 3 inches in height for the raised edges. The dimensions of the base 117 are such that it easily receives the food container 108 and housing chamber 101 to create the present invention animal feeder. Additionally, the base member may have a slanted upper surface that is the slanted floor 116 when the food container 108 is placed on top of the base 117, as in the preferred embodiment of the present invention. As stated above, the base 117, like the other elements of the present invention, can be made of a variety of materials. As in one preferred embodiment of the invention, the base 117 is made of plastic because it is easy to clean, lightweight, and durable. Moreover, the base member 117 may be equipped with latches to secure the food container 108 and housing chamber 101.

Alternatively, the base member 117 may be comprised of two separate pieces 119 and 120 as illustrated in FIGS. 5a and 5b and consistent with one embodiment of the invention. FIG. 5a depicts the invention in the embodiment where one base member 117 is used to receive the food container 108 and the housing chamber 101. In FIG. 5a the slanted floor 116 of the food container 108, and the food-retaining bowl 118, are also labeled for reference. As in the embodiment illustrated in FIG. 5b the first base member 119 may have four raised edges and a top portion that is slanted 116. In this embodiment shown in FIG. 5b, the slanted top 116 leads to the opening 115 that moves the food into the food-retaining bowl 118 when the food container 108 is filled with food, and the food moves down the container and into the food-retaining bowl 118 by gravity. The second base 120, in FIG. 5b is comprised of a bottom floor and three raised edges. As in one preferred embodiment, the height of the raised edges in either base member 117, 119, or 120 is approximately 3 inches. The side not containing a raised edge, in FIG. 5b on the second base 120 connects to the first base 119, having the slanted top 116, opening 115, and food-retaining bowl 118 attached thereto. In this embodiment, the first base 119 is operable to receive the food container 108, which is comprised of four side walls, 110, 111, 112, and 113, and a top wall 109, containing the food-loading door 114. Moreover, the second base 120 is operable to receive the housing chamber 101, which in this embodiment is comprised of a front wall 105, containing a size-excluding door 106, a left side wall 103, and a right side wall 104, as well as a top wall 102. The two base members 119 and 120, connected to the food container 108 and housing chamber 101, may then be connected together to form the animal feeder, as in one embodiment of the invention. Additionally, the invention is operable without the second base 120 such that the housing chamber rests on the floor or surface that the feeding container is on. This embodiment may be advantageous to the user as it then consists of fewer elements to construct the feeding container and may be more convenient for the user.

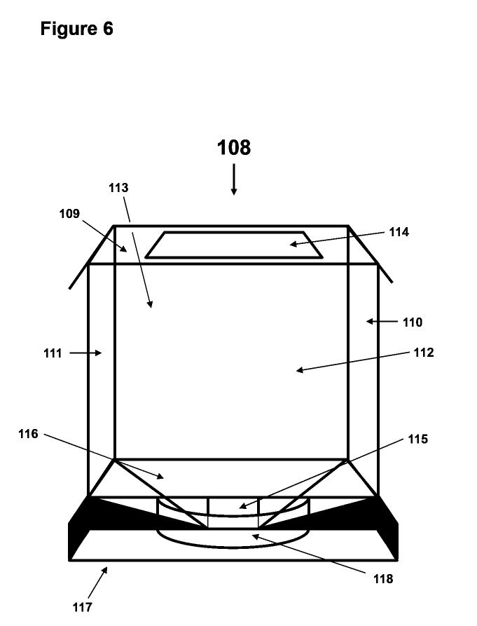

FIG. 6 shows a front view of the animal feeder, all elements are labeled in the same manner as described above. This view shows the character of the slanted floor 116, in one preferred embodiment, and how the slanted floor 116 feeds into the opening 115 so that the food passing therethrough flows into the food-retaining bowl 118.

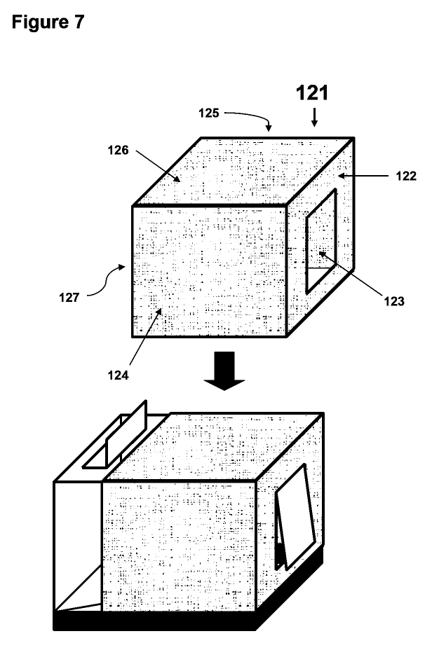

In addition to the description above, as illustrated in FIG. 7, a cover 121 may be fitted to cover the housing chamber 101. Such a cover 121 can be useful to prevent distraction to the feeding animal, providing a sense of security and privacy to the feeding animal. This is especially advantageous where the feeding animal is a domestic cat. The cover 121 may consist of a front panel 122 that contains an opening that may be covered by a door 123 near the same size and shape of the size-excluding door 106, as in one embodiment of the invention. Like the size-excluding door 106, the opening and possible door 123 of the cover 121 permits the feeding animal entry and exit from the housing chamber 101. The cover 121 may also have a left side 124, right side 125, top 126, and back 127 panel. Alternatively, as in one embodiment of the invention, there is no back panel 127. As in the preferred embodiment of the present invention, the cover 121 is opaque in nature. The cover 121, may be fabricated from many known elements such as natural or synthetic fabrics, plastics, epoxies, polymers, woods, metals, and the like. Moreover, it is contemplated that the cover 121 may be fabricated so that it is aesthetically pleasing to the caregiver.

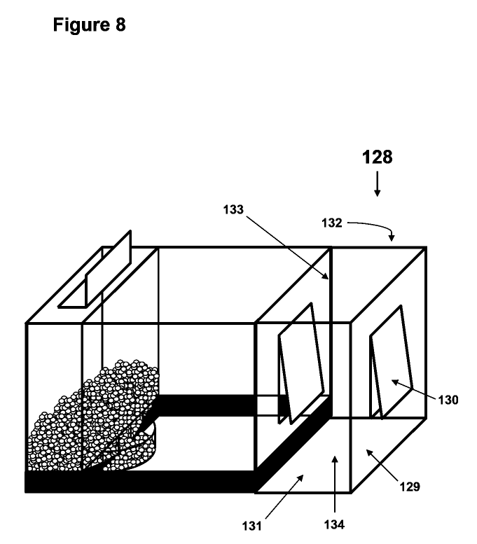

Moreover, an extra chamber 128 may be fitted to the housing chamber 101, as illustrated in FIG. 8. This extra chamber 128, is particularly advantageous where an excluded animal can use its head to enter the housing chamber 101 and access the food-retaining bowl 118, or otherwise disturb the feeding animal. In this embodiment, the extra chamber 128 is made up of a front panel 129, containing an opening with a possible door 130 that excludes a larger animal. The extra chamber 128 also includes a top panel 133, and may include a bottom panel 134 as in one embodiment of the invention. Another embodiment of the present invention does not include the bottom panel 134 of the extra chamber 128.

The length of the left side panel 131 and right side panel 132 are such that a larger excluded animal cannot put its head, or other body part, through the extra chamber door 130 and reach the inner housing chamber 101 size-excluding door 106. In one preferred embodiment of the invention, the height of the extra chamber 128 is the same as that of the housing chamber 101 plus the base, approximately 16 inches. In this preferred embodiment, the length of the extra chamber 128 is approximately 8 inches. The opening with a door 130 of the extra chamber 128 approximates the measurements of the size-excluding door 106 of the housing chamber 101. In a preferred embodiment, the opening and door 130 is approximately 7 inches in height, and 6 inches in length. The door 130 of the extra chamber 128, like the size-excluding door 106 of the housing chamber 101 is attached at its topmost side. The door 130 retains the ability to swing inward to the housing chamber 101 when pressure is applied, and swing outward when the feeding animal exits the extra chamber 128.

Many means of attaching the door 130 to the extra chamber 128 are contemplated, and are similar to those means described above for the size-excluding door 106 and its attachment to the housing chamber 101. In one preferred embodiment the door 130 is affixed to the extra chamber 128 by mechanism that allows the door to swing freely into and out of the chamber. Moreover, the extra chamber 128 may be fabricated with a variety of materials such as plastics, polymers, epoxies, natural and synthetic fibers, metals, or woods. In one preferred embodiment the extra chamber 128 is made of IRIS, USA plastic. This preferred embodiment allows for easy cleaning, is lightweight, and durable.

I claim:

1. A feeding container comprising:
a base member operable to receive: at least one food container, said food container having at least one opening operable to receive a plurality of food and contain said plurality of food, and said food container having at least one opening operable to allow said plurality of food to flow from said food container into a food containing member; and a housing chamber wherein said housing chamber is adjacent to said food container and said housing chamber has at least one opening that is of a size that excludes a larger animal and permits a smaller animal access to said plurality of food in said food containing member contained therein.

2. The feeding container of claim 1, wherein said food container has a sloped bottom panel, wherein the lower edge of said sloped bottom panel is adjacent to said opening operable to allow said plurality of food to flow from said food container.

3. The feeding container of claim 1, wherein said food containing member is a food retaining bowl that is attached to said base member such that when said food container is placed on said base member, said opening operable to allow said plurality of food to flow from said food container releases said plurality of food into said food retaining bowl.

4. The feeding container of claim 1, wherein said food container may hold an amount of said plurality of food to feed said smaller animal for a plurality of days.

5. The feeding container of claim 1, wherein said opening operable to allow a plurality of food to be placed within said food container has a cover operable to close said opening.

6. The feeding container of claim 1, wherein the said container is manufactured from plastic.

7. The feeding container of claim 1, wherein said base member has an upper panel that is sloped in the region that receives said food container such that when said plurality of food is placed within said food container, said food may move down said upper panel that is sloped and out of said opening operable to allow said plurality of food to flow out of said food container.

8. The feeding container of claim 1, where in a cover is operable to be placed on said housing chamber and said cover is opaque and may provide added privacy to said smaller animal.

9. The feeding container of claim 1, wherein a extended chamber may be placed adjacent to said housing chamber, said housing chamber comprising a door that is of a size that excludes a larger animal and permits a smaller animal access to said housing chamber, wherein said extended chamber provides further obstruction to said plurality of food to said larger animal.

10. A feeding container comprising:
at least one base member operable to connect to each other base members to form a base with raised edges, said base operable to receive:
a food container having at least two openings, the first said opening operable to load the food container with a plurality of food and having a cover operable to close, and a said second opening operable to allow said plurality of food to flow out of said food container and into a food containing member;
and a housing chamber having at least one opening of a size that excludes a larger animal and permits a smaller animal access, said opening having a door attached thereto, said door having the ability to move in and out of said food container when pressure is applied.

11. The feeding container of claim 10, wherein said food container has a sloped bottom panel, wherein the lower edge of said sloped bottom panel is adjacent to said opening operable to allow said plurality of food to flow from said food container.

12. The feeding container of claim 10, wherein said food containing member is a food retaining bowl that is attached to said base with raised edges such that when said food container is placed on said base with raised edges, said opening operable to allow said plurality of food to flow from said food container releases said plurality of food into said food retaining bowl.

13. The feeding container of claim 10, wherein said food container may hold an amount of said plurality of food to feed said smaller animal for a plurality of days.

14. The feeding container of claim 10, wherein said base with raised edges has an upper panel that is sloped in the region that receives said food container such that when said plurality of food is placed within said food container, said food may move down said upper panel that is sloped and out of said opening operable to allow said plurality of food to flow out of said food container.

15. The feeding container of claim 10, wherein said base is only one piece operable to receive said food container, and there is no base underneath said housing chamber.

16. The feeding container of claim 10, where in a cover is operable to be placed on said housing chamber and said cover is opaque and may provide added privacy to said smaller animal.

17. The feeding container of claim 10, wherein a extended chamber may be placed adjacent to said housing chamber, said housing chamber comprising a door that is of a size that excludes a larger animal and permits a smaller animal access to said housing chamber, wherein said extended chamber provides further obstruction to said plurality of food to said larger animal.

18. A feeding container comprising:
at least two base members wherein at least one of said base members contains raised edges such that when coupled to at least another of said base members with raised edges, the raised edges are continuous around the perimeter of said feeding container, creating a base with raised edges and further comprising a sloped upper panel on said at least one of said base members that is operable to receive a food container, and a food retaining bowl on the side of said at least one of said base members without a raised edge and adjacent to the lower portion of said sloped upper panel, said at least two base members operable to receive;
a food container having at least two openings wherein at least one of said openings is operable to receive a plurality of food that may feed said smaller animal for a multitude of days and has a cover to close said at least one of said openings and wherein at least another of said openings is operable to release said plurality of food as said plurality of food moves down said sloped upper panel and into said food retaining bowl; and
a housing chamber with at least one opening of a size that excludes a larger animal and permits a smaller animal access, said opening having a door attached thereto and said door having the ability to move in and out of said food container when pressure is applied.

19. The feeding container of claim 18, where in a cover is operable to be placed on said housing chamber and said cover is opaque and may provide added privacy to said smaller animal.

20. The feeding container of claim 18, wherein a extended chamber may be placed adjacent to said housing chamber, said housing chamber comprising a door that is of a size that excludes a larger animal and permits a smaller animal access to said housing chamber, wherein said extended chamber provides further obstruction to said plurality of food to said larger animal.
